(19) United States
(12) Patent Application Publication
(10) Pub. No.: US 2014/0344168 A1
(43) Pub. Date: Nov. 20, 2014

(54) Object Related Collaboration

(71) Applicant: SAP AG, Walldorf (DE)

(72) Inventor: Peter Fitz, Waldsee (DE)

(73) Assignee: SAP AG, Walldorf (DE)

(21) Appl. No.: 13/894,064

(22) Filed: May 14, 2013

(51) Int. Cl. G06Q 10/10

(52) U.S. Cl. CPC G06Q 10/101
USPC 705/300

(57) ABSTRACT

A collaboration platform employs collaboration objects to automatically construct virtual groupings of individuals sharing a common interest, thereby promoting collaboration. The collaboration platform includes a collaboration engine in communication with business object(s) (e.g. a purchase order document) of an application layer. Based upon masterdata (e.g. a product name) compiled from the business object(s), the collaboration engine creates collaboration object data structures that include information relevant to collaboration. Such collaboration objects may link particular individuals to relevant masterdata. According to one example, an engineer creates a new bill of material in the system which includes a specific product. This product is subject of a purchasing order created by purchasing agent. From the collaboration object(s), the collaboration engine may automatically construct virtual groupings of individuals (e.g. the engineer and the purchasing agent) sharing a common interest (e.g. the product), thereby promoting collaboration.

### BACKGROUND

Embodiments of the present invention relate to collaboration techniques, and in particular, to object related collaboration approaches.

Unless otherwise indicated herein, the approaches described in this section are not prior art to the claims in this application and are not admitted to be prior art by inclusion in this section.

Conventionally, collaboration tools require a user to be registered to a network, and for that user to follow another user or to join a special group in order to be part of a particular discussion. Often, however, a third party having relevant information or helpful advice may not be known to the user and may not be part of a particular discussion group.

Accordingly, the present disclosure addresses these and other issues with collaboration techniques involving object related collaboration.

### SUMMARY

A collaboration platform employs collaboration objects to automatically construct virtual groupings of individuals sharing a common interest, thereby promoting collaboration. The collaboration platform includes a collaboration engine in communication with business object(s) (e.g. a purchase order document) of an application layer. Based upon masterdata (e.g. a product name) compiled from the business object(s), the collaboration engine creates collaboration object data structures that include information relevant to collaboration. Such collaboration objects may link particular individuals to relevant masterdata. According to one example, an engineer creates a new bill of material in the system which includes a specific product. This product is subject of a purchasing order created by purchasing agent. From the collaboration object(s), the collaboration engine may automatically construct virtual groupings of individuals (e.g. the engineer and the purchasing agent) sharing a common interest (e.g. the product), thereby promoting collaboration.

An embodiment of a computer-implemented method comprises, providing a business object comprising a masterdata object, causing a collaboration engine to reference the masterdata object to create a collaboration object linking a first individual to the masterdata object, and causing the collaboration engine to recognize relevance of the masterdata object, to a second individual. The method further comprises causing the collaboration engine to reference the collaboration object to create a virtual grouping comprising the first individual and the second individual, and causing the collaboration engine to communicate to the first individual, information relevant to the masterdata object.

An embodiment of a non-transitory computer readable storage medium embodies a computer program for performing a method. The method comprises providing a business object comprising a masterdata object, causing a collaboration engine to reference the masterdata object to create a collaboration object linking a first individual to the masterdata object, and causing the collaboration engine to recognize relevance of the masterdata object, to a second individual. The collaboration engine is caused to reference the collaboration object to create a virtual grouping comprising the first individual and the second individual. The collaboration engine is caused to communicate to the first individual, information relevant to the masterdata object.

An embodiment of a computer system comprises one or more processors and a software program, executable on said computer system. The software program is configured to provide a business object comprising a masterdata object, cause a collaboration engine to reference the masterdata object to create a collaboration object linking a first individual to the masterdata object, and cause the collaboration engine to recognize relevance of the masterdata object, to a second individual. The software program is configured to cause the collaboration engine to reference the collaboration object to create a virtual grouping comprising the first individual and the second individual. The software program is configured to cause the collaboration engine to communicate to the first individual, information relevant to the masterdata object.

In an embodiment the business object comprises a document, and the masterdata object comprises a document field.

According to some embodiments the collaboration engine recognizes the relevance of the masterdata object to the second individual, based upon a communication involving the second individual.

Some embodiments further comprise causing the collaboration engine to permit a third individual to have access to the virtual grouping, and causing the collaboration engine to allow the third individual to join the virtual grouping upon receipt of a request by the third individual.

In particular embodiments the collaboration engine creates the virtual grouping only if the first individual and the second individual are affiliated with a same business organization.

According to various embodiments the collaboration engine creates the virtual grouping even if the first individual and the second individual are affiliated with different business organizations.

The following detailed description and accompanying drawings provide a better understanding of the nature and advantages of particular embodiments.

### BRIEF DESCRIPTION OF THE DRAWINGS

FIG. 1 shows a simplified view of an object related collaboration system according to an embodiment.

FIG. 1A is a simplified flow diagram illustrating an object related collaboration method according to an embodiment.

FIG. 2 is a screenshot showing daily work activity generating structured information that may be leveraged to perform collaboration according to an embodiment.

FIG. 3 illustrates creation of a virtual group based upon a hierarchy.

FIG. 4 is a screen shot illustrating creation of a virtual grouping for collaboration.

FIG. 5 illustrates hardware of a special purpose computing machine configured to perform object related collaboration according to an embodiment.

FIG. 6 illustrates an example of a computer system.

### DETAILED DESCRIPTION

Described herein are techniques for object related collaboration. The apparatuses, methods, and techniques described below may be implemented as a computer program (software) executing on one or more computers. The computer program may further be stored on a computer readable medium. The computer readable medium may include instructions for performing the processes described below.

In the following description, for purposes of explanation, numerous examples and specific details are set forth in order to provide a thorough understanding of the present invention. It will be evident, however, to one skilled in the art that the present invention as defined by the claims may include some or all of the features in these examples alone or in combination with other features described below, and may further include modifications and equivalents of the features and concepts described herein.

A collaboration platform employs collaboration objects to automatically construct virtual groupings of individuals sharing a common interest, thereby promoting collaboration. The collaboration platform includes a collaboration engine in communication with business object(s) (e.g. a purchase order document) of an application layer. Based upon masterdata (e.g. a product name) compiled from the business object(s), the collaboration engine creates collaboration object data structures that include information relevant to collaboration. Such collaboration objects may link particular individuals to relevant masterdata. According to one example, an engineer creates a new bill of material in the system which includes a specific product. This product is subject of a purchasing order created by purchasing agent. From the collaboration object(s), the collaboration engine may automatically construct virtual groupings of individuals (e.g. the engineer and the purchasing agent) sharing a common interest (e.g. the product), thereby promoting collaboration.

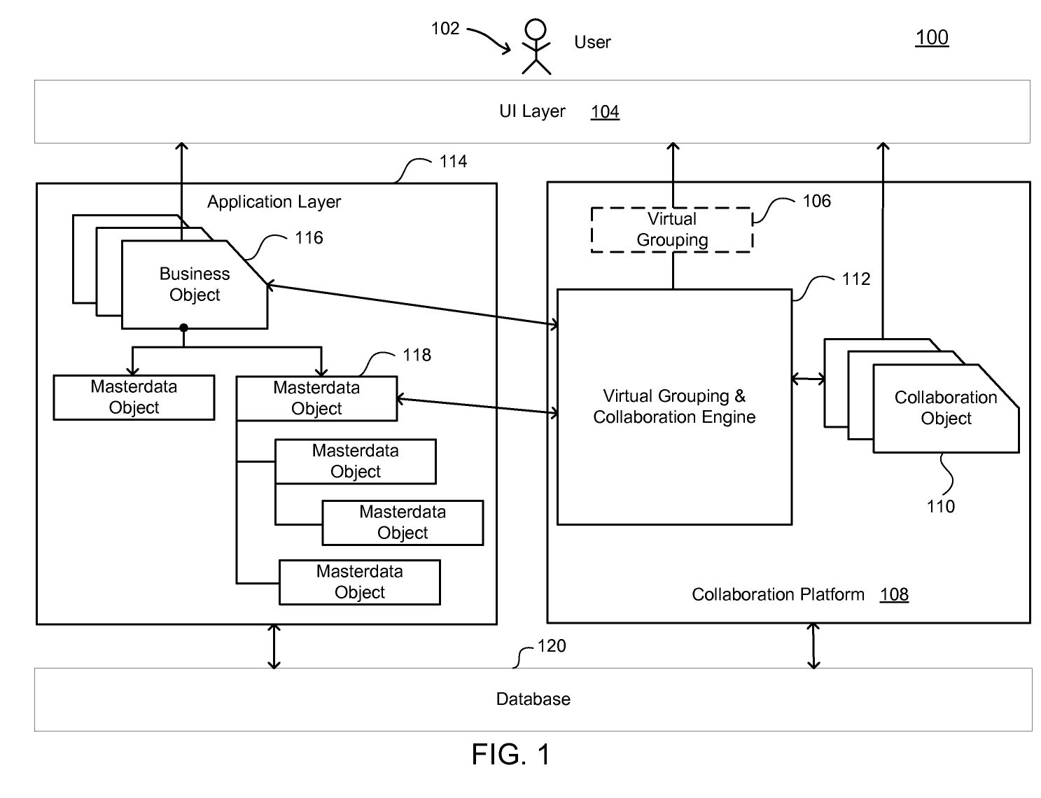

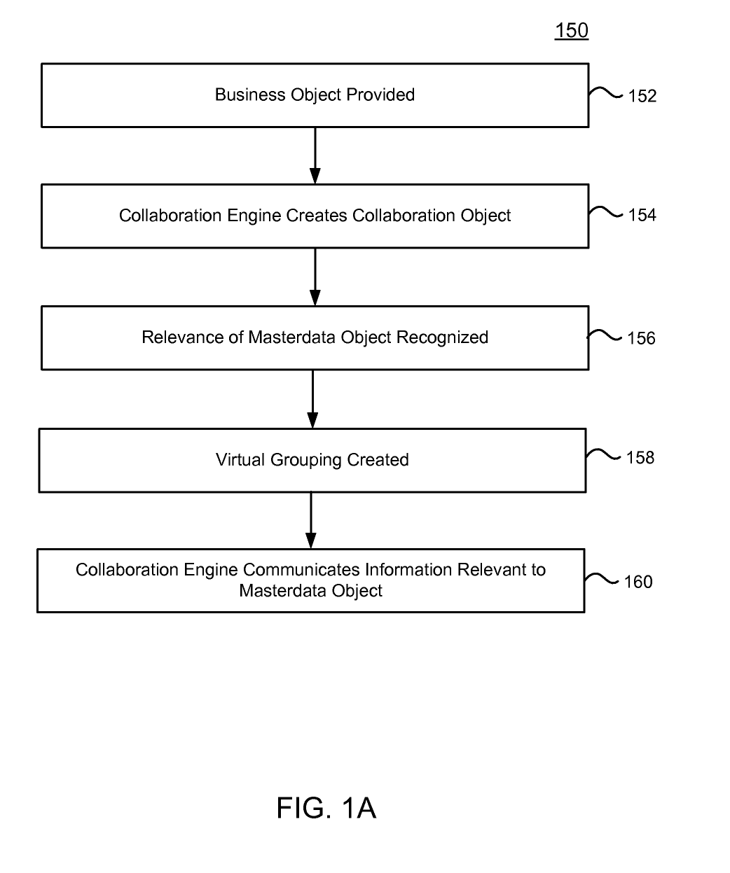

FIG. 1 shows a simplified view of an object related collaboration system according to an embodiment. In particular, FIG. 1 shows a system 100 wherein user 102 is in communication with data of an underlying database 120, via a user interface (UI) layer 104 and an intervening application layer 114.

Stored within the application layer are a series of business objects 116, which comprise data of the database stored according to a particular data structure that is of value to the user. One example of such a business object is a particular document (e.g. a purchase order).

Business object 116 has its own structure (e.g. object header, items). In the header and in the items, the business object refers to several masterdata objects 118. For example, the header has a reference to the supplier; an item has a reference to a product (e.g. material or service). The master data itself may have a hierarchical structure.

In the particular context of a business object comprising a document (e.g. a purchase order), the masterdata objects may comprise particular data elements within the document. Examples of such masterdata objects may include but are not limited to: author, date, subject matter line, document type, key words, etc.

In such a document-type business object, the masterdata object of “product” (e.g. a product referenced in the document), may be located in a hierarchy under the masterdata object of “manufacturer”. Such a hierarchy reflects the affiliation of multiple products to a single manufacturer. If the business object is a purchase order, this reflects that the product will be ordered from a specific supplier/manufacturer.

FIG. 1 shows a collaboration platform 108 according to an embodiment. The collaboration platform also lies between the UI layer and the underlying database. The collaboration platform comprises a plurality of collaboration objects 110. Again, these collaboration objects reflect data from the underlying database, organized according to a particular structure.

Here, the collaboration objects contain data relevant to collaboration activities. For example, a collaboration object may include not only product data, but also personal data of individuals having some sort of nexus with that particular product. Thus, a collaboration object may include in its data structure, a product together with the names and contact information for purchasing agent(s), supplier representative(s), field installer(s), accountants, and/or others.

As shown in FIG. 1, the various individuals associated in a particular group, are designated as a “Virtual Grouping” 106. A virtual grouping may be limited within an organization, or alternatively it may span multiple organizations (e.g. a user of the particular product within a customer company, and a contact at a vendor of the product).

The collaboration platform further comprises a virtual grouping and collaboration engine 112. This engine 112 is configured to interact with the business objects of the application layer, including their respective masterdata objects. From this interaction, the engine is configured to create and modify the collaboration objects, and to disseminate information to the user interface via the virtual grouping.

Further details regarding operation of the virtual grouping and collaboration engine 112 of the collaboration platform, is now provided, particularly in conjunction with the Example given below.

FIG. 1A shows a simplified process flow of object related collaboration method 150 according to an embodiment. In a first step 152, a business object comprising a masterdata object is provided. In a second step 154, a collaboration engine is caused to reference the masterdata object to create a collaboration object linking a first individual to the masterdata object. In a third step 156, the collaboration engine is caused to recognize relevance of the masterdata object, to a second individual. In a fourth step 158, the collaboration engine is caused to reference the collaboration object to create a virtual grouping comprising the first individual and the second individual. In a fifth step 160, the collaboration engine is caused to communicate to the first individual, information relevant to the masterdata object. Examples of such information can include but are not limited to questions/feeds one of the individuals has started.

Embodiments of object related collaboration approaches allow relevant information to be accessible to a user, such that the user may be connected to valuable sources of information depending upon their daily business activity. Thus according to certain embodiments, object related collaboration approaches leverage structured information normally available in various business systems within an application layer, in order to conduct collaboration between users. Examples of such business systems include but are not limited to: Enterprise Resource Planning (ERP) systems, Supplier Relationship Management (SRM) systems, Customer Relationship Management (CRM) systems, financial (FIN) systems, or human resource (HR) systems. These systems may be located on-premises, or on-demand.

In an example, an individual user of a business system may be a purchaser or a sales representative, and thus belong to an internal organization such as a purchasing department or a sales organization. When this user logs onto the system, she normally has a particular role with assigned attributes (for example access rights).

According to embodiments, collaboration systems as described herein may leverage this structured information (e.g. organizational membership, access rights) in order to accurately determine a sphere of peers and coworkers, and facilitate collaboration therewith as a virtual grouping. This collaboration may be accomplished through the creation and maintenance of collaboration objects.

Apart from information pertaining to organizational membership and access rights, a wealth of information relevant to potential collaboration is also typically available. For example, during her daily work, the user may accumulate structured data such as a product relied upon by the user. Such a product belongs to particular product category, information which can also be used in performing object related collaboration activities. Also, a product ID may be an attribute of a particular product.

Many other types of structured information may be relied upon for collaboration according to embodiments. Examples can include but are not limited to, the assignment of a supplier to a purchase request by the user, and the user's creation of a sales order for a specific customer.

Such stored information as organizational affiliation and product category, may be of particular value by offering enduring links that identify possible spheres of fruitful collaboration by a user. Thus certain embodiments may generate virtual groupings or areas of interest, where a user can read feeds or ask questions to a relevant collaboration group. The user may be seamlessly assigned to such collaboration groupings, without requiring active designation by the user.

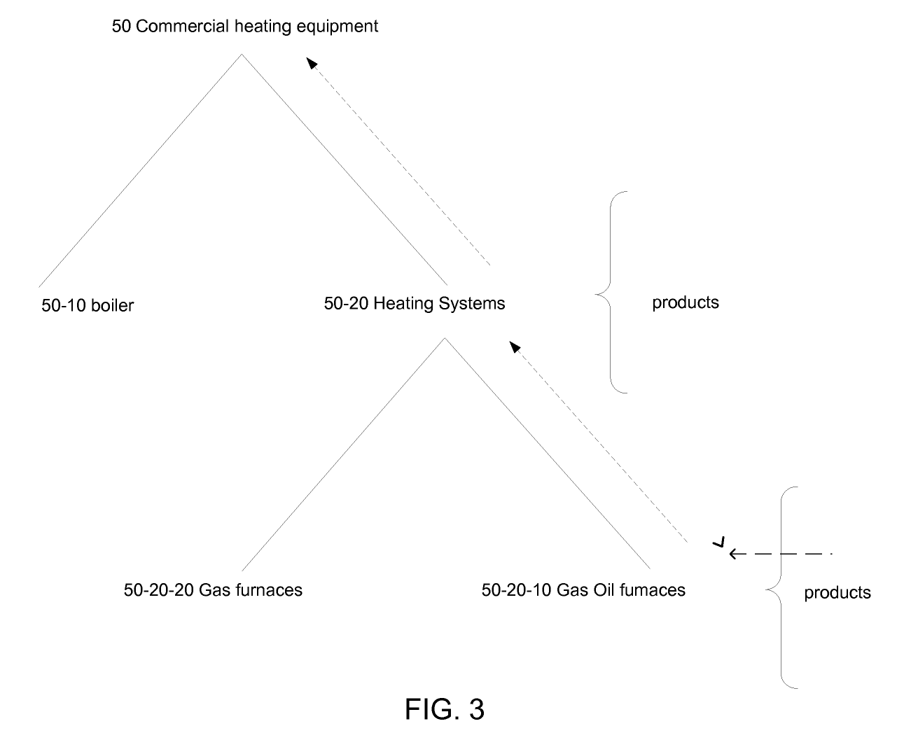

Such spontaneous creation of a collaboration group, is not restricted to being based upon a single item of information. For example, the user's association with a product may take the form of not only a product category, but also additional information such as the product's category hierarchy (e.g. see FIG. 3 discussed below). In this manner, multiple pieces of structured information may be considered in creating and organizing a collaboration group according to an embodiment.

Linkages between a specific user and structured information relevant to collaboration, may be established in various ways.

If a user is already logged onto a system, manually created feeds may be immediately assigned to the organization the user belongs to, as a default. Thus if the user creates a feed, that information will be automatically assigned to the virtual grouping.

As an example, the user may belong to the specific sales organization “Europe”. Upon returning from a customer visit, the user may write: “I visited our customer ‘XX’, and now I'm back in the office”. According to embodiments, this feed or statement may automatically be linked to the virtual grouping “Europe”, without the user having to expend the time and energy to explicitly and actively create such a collaboration group.

By focusing on daily work activities, embodiments may commence a feed when, for example, a purchaser is creating purchase order. This daily activity will bind the information directly to the object of interest.

For example, the user may ask a question relevant to the particular supplier: e.g. “Did they solve their quality problems?”. Or, the user may ask a question for a particular product: e.g. “Can this product be replaced by a cheaper one?”

### EXAMPLE

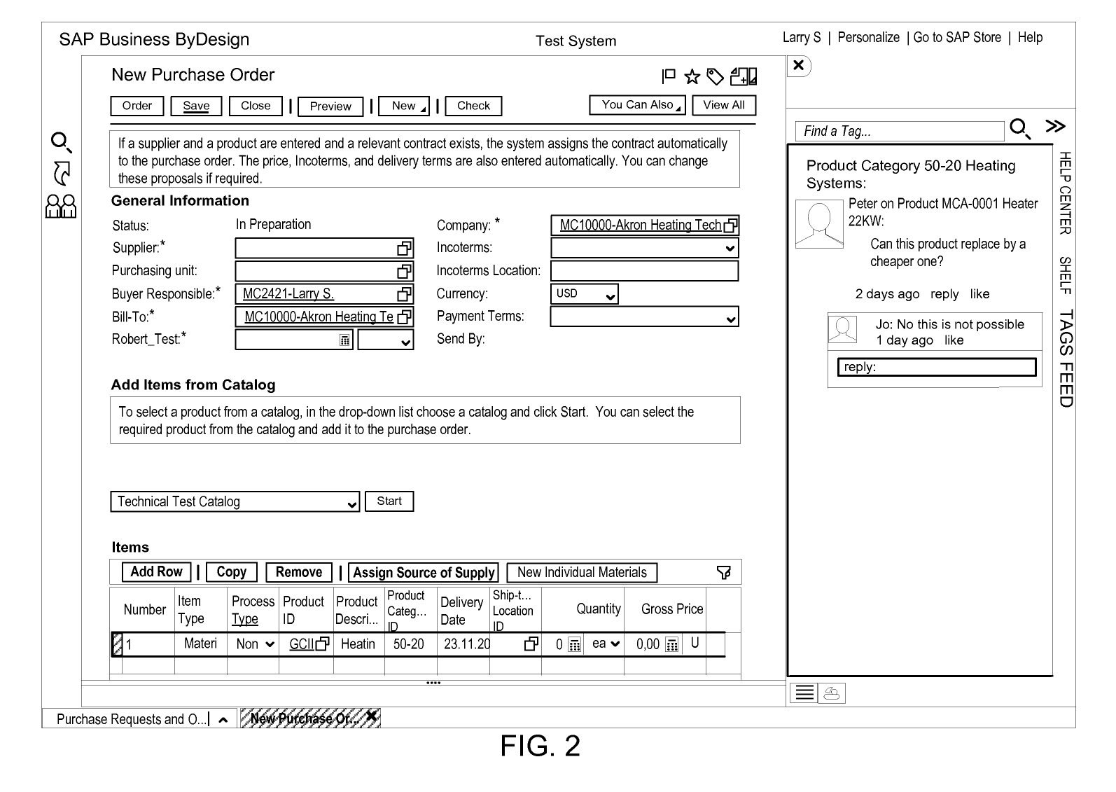

FIG. 2 is a screenshot showing daily work activity generating structured information that may be leveraged to perform collaboration according to an embodiment. In particular, FIG. 2 shows the creation of a purchase order for a product (here in the field of heating) by a user.

According to object related collaboration, a virtual grouping may be automatically created for a product. This may be done by leveraging master data used in the document. Examples of such master data may include information relating to:
supplier;
contact;
organizational information (e.g. purchasing unit, purchasing group, ship to, account assignment/cost center);
product;
product category; and
account.

Embodiments may leverage information present in a wide variety of document types, in order to facilitate collaboration. Examples of such document types may include but are not limited to, sales orders, quotes, request for quotations, shopping carts, and purchase orders, catalog pages, price lists, as well as others.

A benefit conferred, is the creation of implicit underlying information. For example, it is known that this product belongs to a product category and this category is part of a product category hierarchy. Such accumulation of enhanced information can result in the possibility to support the flow of this knowledge to colleagues who are interested and/or able to help with a particular issue.

The flow of information may be as shown in FIG. 1. If someone has assigned a feed to a masterdata object of a business object, a virtual grouping is created by the engine. Now, the additional collaboration information will be used without limiting access to potential viewers.

In this particular example, only employees having a connection with the product will automatically be a part of this virtual grouping. Thus if a sales employee creates a sales order for a customer, where this product is part of the sales order, the sales employee will see the feed.

The product belongs to a product category. The category is the next virtual group which is created, and product category belongs to a hierarchy. FIG. 3 gives an example.

In particular, the dashed arrows of FIG. 3 show the flow of the feeds/information and the potential virtual groupings. If a user works on documents with products in the category “50-20 Heating”, she will see all of the feeds which were assigned to products in the sub-category “50-10-10 Oil furnaces”.

Such a flow of information can be employed wherever a relationship such as a hierarchy or a grouping, exists. Other examples of relationships can include but are not limited to an organizational structure of a company, an industry to which a supplier belongs, and product categories assigned to a particular supplier.

With this information, the system is able to communicate feeds which may be of interest to a user in her daily work. The user can readily comment on the feeds, and/or start new feeds.

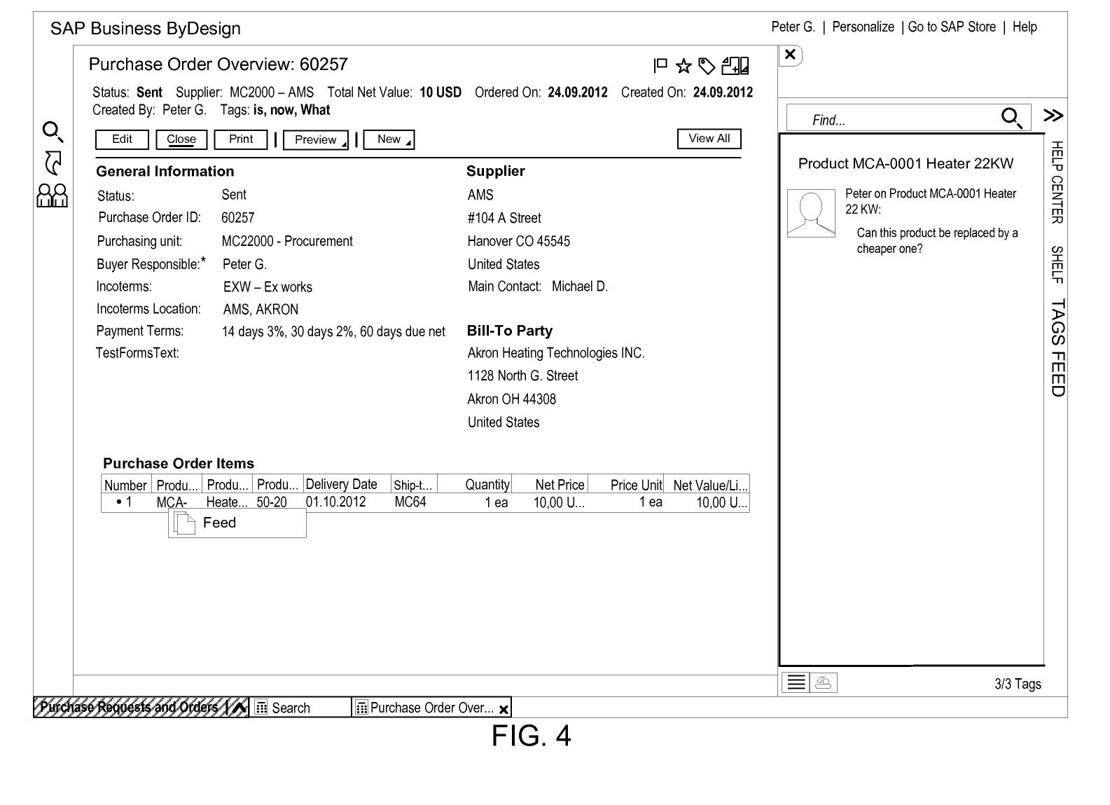

FIG. 4 shows an example where the system devises a feed by creating a virtual grouping based on the hierarchy of product categories. The feed seen by the purchaser belongs to the product “MCA-0001”, which belongs to the category “50-20-10”.

That feed is also in the virtual group “50-20” pursuant to the hierarchy of product categories spelled out in the FIG. 3. So, the information/feed comes up also in this example. The information is relevant, because it can be a part of the heating coil and has an effect on the price, or because the purchaser in this example can also give a reply to the ongoing discussion.

FIG. 2 shows this. In the FIG. 2, the product belongs to the category 50-20-10 and there are seen the questions from FIG. 4, together with the answer another individual has given.

Feeds may be sorted by creation time. With such virtually created groups, the group (masterdata) to which the feed originally belongs, may be accessed. If a user works on a document (e.g. where products from categories belonging to a hierarchy are used), the collaboration system may use only the highest category in spontaneously creating the virtual group.

The screen shot of FIG. 4 illustrates creation of a virtual grouping for collaboration. Thus according to the hierarchy shown in FIG. 3, a product from category “50-10-10 Oil furnaces” and a product from category “50-20 Heating” are used, the virtual group shown on the collaboration window (for example Jam!™) is the last one.

The particular screen shot of FIG. 4 represents only one example. If for instance, in a purchase order two products are ordered—one out of category “50-10-10 Oil furnaces”, and one out of category “50-20 Heating”—then the last one may be used for grouping for this user at the moment the user works on the purchase order. Such a situation is not reflected in the FIG. 4 because in that purchase order, only one product is used.

A user entering the collaboration platform directly, may be able to browse for the virtual groups, and can be able follow such a virtual group. Such direct access may be optional, however, because the user is not acting within the context of her business system.

Object related collaboration approaches according to various embodiments may offer certain benefits. For example, object related collaboration approaches may allow external users to be included in relevant feeds and/or discussions. Thus according to certain embodiments, outside suppliers may be included in collaboration over a supplier portal or in a market place environment.

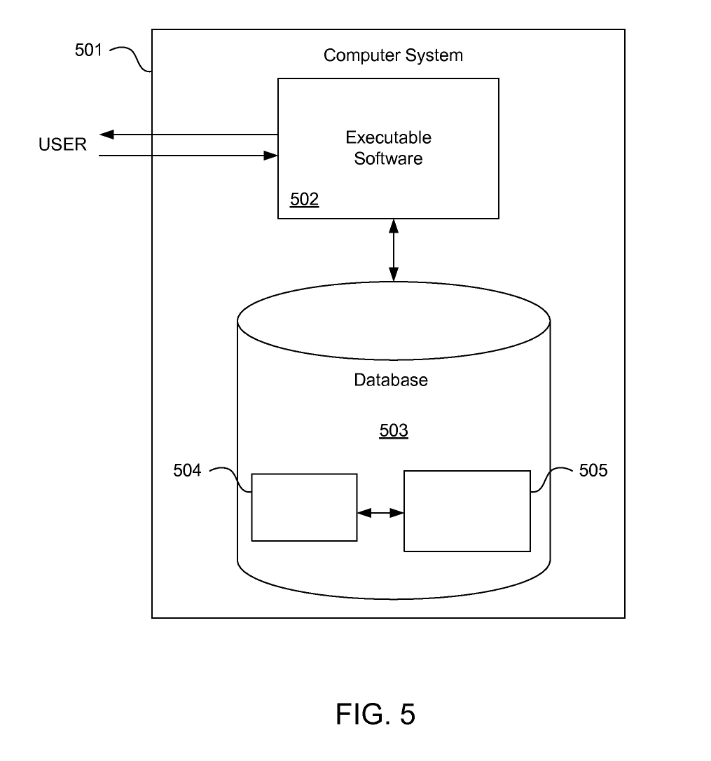

FIG. 5 illustrates hardware of a special purpose computing machine configured to implement object related collaboration according to an embodiment. In particular, computer system 500 comprises a processor 502 that is in electronic communication with a non-transitory computer-readable storage medium 503. This computer-readable storage medium has stored thereon code 505 corresponding to a virtual grouping and collaboration engine. Code 504 corresponds to a collaboration object. Code may be configured to reference data stored in a database of a non-transitory computer-readable storage medium, for example as may be present locally or in a remote database server. Software servers together may form a cluster or logical network of computer systems programmed with software programs that communicate with each other and work together in order to process requests.

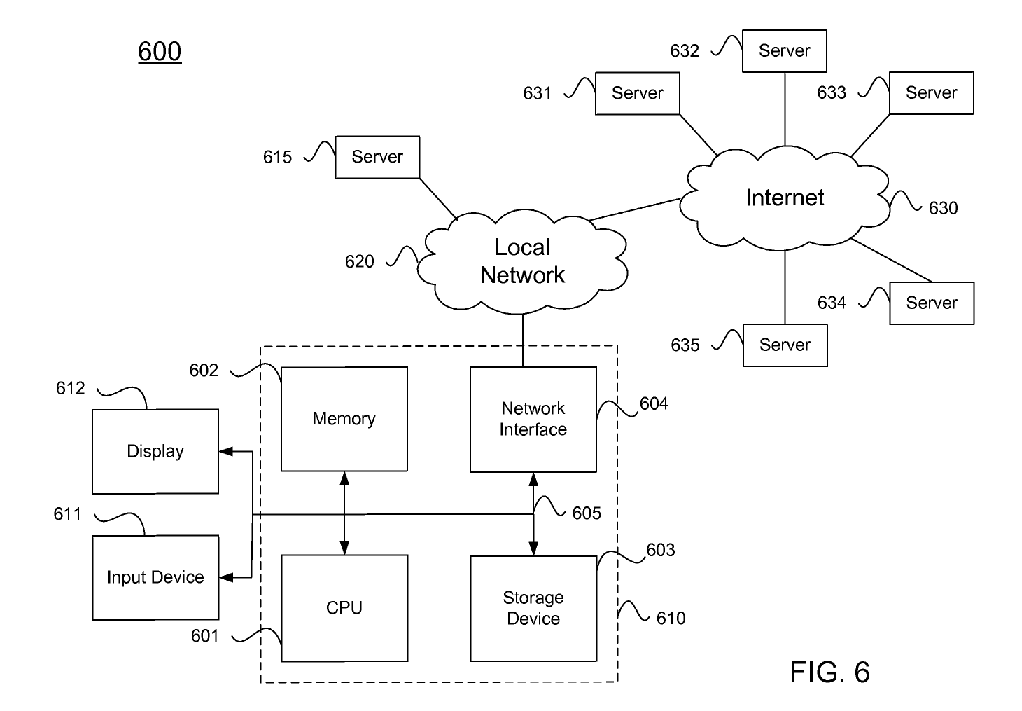

An example computer system 610 is illustrated in FIG. 6. Computer system 610 includes a bus 605 or other communication mechanism for communicating information, and a processor 601 coupled with bus 605 for processing information. Computer system 610 also includes a memory 602 coupled to bus 605 for storing information and instructions to be executed by processor 601, including information and instructions for performing the techniques described above, for example. This memory may also be used for storing variables or other intermediate information during execution of instructions to be executed by processor 601. Possible implementations of this memory may be, but are not limited to, random access memory (RAM), read only memory (ROM), or both. A storage device 603 is also provided for storing information and instructions. Common forms of storage devices include, for example, a hard drive, a magnetic disk, an optical disk, a CD-ROM, a DVD, a flash memory, a USB memory card, or any other medium from which a computer can read. Storage device 603 may include source code, binary code, or software files for performing the techniques above, for example. Storage device and memory are both examples of computer readable mediums.

Computer system 610 may be coupled via bus 605 to a display 612, such as a cathode ray tube (CRT) or liquid crystal display (LCD), for displaying information to a computer user. An input device 611 such as a keyboard and/or mouse is coupled to bus 605 for communicating information and command selections from the user to processor 601. The combination of these components allows the user to communicate with the system. In some systems, bus 605 may be divided into multiple specialized buses.

Computer system 610 also includes a network interface 604 coupled with bus 605. Network interface 604 may provide two-way data communication between computer system 610 and the local network 620. The network interface 604 may be a digital subscriber line (DSL) or a modem to provide data communication connection over a telephone line, for example. Another example of the network interface is a local area network (LAN) card to provide a data communication connection to a compatible LAN. Wireless links are another example. In any such implementation, network interface 604 sends and receives electrical, electromagnetic, or optical signals that carry digital data streams representing various types of information.

Computer system 610 can send and receive information, including messages or other interface actions, through the network interface 604 across a local network 620, an Intranet, or the Internet 630. For a local network, computer system 610 may communicate with a plurality of other computer machines, such as server 615. Accordingly, computer system 610 and server computer systems represented by server 615 may form a cloud computing network, which may be programmed with processes described herein. In the

Internet example, software components or services may reside on multiple different computer systems 610 or servers 631-635 across the network. The processes described above may be implemented on one or more servers, for example. A server 631 may transmit actions or messages from one component, through Internet 630, local network 620, and network interface 604 to a component on computer system 610. The software components and processes described above may be implemented on any computer system and send and/or receive information across a network, for example.

The above description illustrates various embodiments of the present invention along with examples of how aspects of the present invention may be implemented. The above examples and embodiments should not be deemed to be the only embodiments, and are presented to illustrate the flexibility and advantages of the present invention as defined by the following claims. Based on the above disclosure and the following claims, other arrangements, embodiments, implementations and equivalents will be evident to those skilled in the art and may be employed without departing from the spirit and scope of the invention as defined by the claims.

What is claimed is:

1. A computer-implemented method comprising:
providing a business object comprising a masterdata object;
causing a collaboration engine to reference the masterdata object to create a collaboration object linking a first individual to the masterdata object;
causing the collaboration engine to recognize relevance of the masterdata object, to a second individual;
causing the collaboration engine to reference the collaboration object to create a virtual grouping comprising the first individual and the second individual; and
causing the collaboration engine to communicate to the first individual, information relevant to the masterdata object.

2. A method as in claim 1 wherein the business object comprises a document, and the masterdata object comprises a document field.

3. A method as in claim 1 wherein the collaboration engine recognizes the relevance of the masterdata object to the second individual, based upon a communication involving the second individual.

4. A method as in claim 1 further comprising:
causing the collaboration engine to permit a third individual to have access to the virtual grouping; and
causing the collaboration engine to allow the third individual to join the virtual grouping upon receipt of a request by the third individual.

5. A method as in claim 1 wherein the collaboration engine creates the virtual grouping only if the first individual and the second individual are affiliated with a same business organization.

6. A method as in claim 1 wherein the collaboration engine creates the virtual grouping even if the first individual and the second individual are affiliated with different business organizations.

7. A non-transitory computer readable storage medium embodying a computer program for performing a method, said method comprising:
providing a business object comprising a masterdata object;
causing a collaboration engine to reference the masterdata object to create a collaboration object linking a first individual to the masterdata object;
causing the collaboration engine to recognize relevance of the masterdata object, to a second individual;
causing the collaboration engine to reference the collaboration object to create a virtual grouping comprising the first individual and the second individual; and
causing the collaboration engine to communicate to the first individual, information relevant to the masterdata object.

8. A non-transitory computer readable storage medium as in claim 7 wherein the business object comprises a document, and the masterdata object comprises a document field.

9. A non-transitory computer readable storage medium as in claim 7 wherein the collaboration engine recognizes the relevance of the masterdata object to the second individual, based upon a communication involving the second individual.

10. A non-transitory computer readable storage medium as in claim 7 wherein the method further comprises:
causing the collaboration engine to permit a third individual to have access to the virtual grouping; and
causing the collaboration engine to allow the third individual to join the virtual grouping upon receipt of a request by the third individual.

11. A non-transitory computer readable storage medium as in claim 7 wherein the collaboration engine creates the virtual grouping only if the first individual and the second individual are affiliated with a same business organization.

12. A non-transitory computer readable storage medium as in claim 7 wherein the collaboration engine creates the virtual grouping even if the first individual and the second individual are affiliated with different business organizations.

13. A computer system comprising:
one or more processors;
a software program, executable on said computer system, the software program configured to:
provide a business object comprising a masterdata object;
cause a collaboration engine to reference the masterdata object to create a collaboration object linking a first individual to the masterdata object;
cause the collaboration engine to recognize relevance of the masterdata object, to a second individual;
cause the collaboration engine to reference the collaboration object to create a virtual grouping comprising the first individual and the second individual; and
cause the collaboration engine to communicate to the first individual, information relevant to the masterdata object.

14. A computer system as in claim 13 wherein the business object comprises a document, and the masterdata object comprises a document field.

15. A computer system as in claim 13 wherein the collaboration engine recognizes the relevance of the masterdata object to the second individual, based upon a communication involving the second individual.

16. A computer system as in claim 13 wherein the software program is further configured to:
cause the collaboration engine to permit a third individual to have access to the virtual grouping; and
cause the collaboration engine to allow the third individual to join the virtual grouping upon receipt of a request by the third individual.

17. A computer system as in claim 13 wherein the collaboration engine creates the virtual grouping only if the first individual and the second individual are affiliated with a same business organization.

18. A computer system as in claim 13 wherein the collaboration engine creates the virtual grouping even if the first individual and the second individual are affiliated with different business organizations.
